(19) United States
(12) Patent Application Publication
(10) Pub. No.: US 2013/0155308 A1
(43) Pub. Date: Jun. 20, 2013

(54) METHOD AND APPARATUS TO ENHANCE DETAILS IN AN IMAGE

(71) Applicants: Hung-Hsin Wu, San Diego, CA (US); Karthikeyan Shanmugavadivelu, San Diego, CA (US); Wan Shun Vincent Ma, San Diego, CA (US)

(72) Inventors: Hung-Hsin Wu, San Diego, CA (US); Karthikeyan Shanmugavadivelu, San Diego, CA (US); Wan Shun Vincent Ma, San Diego, CA (US)

(73) Assignee: QUALCOMM Incorporated, San Diego, CA (US)

(21) Appl. No.: 13/332,272

(22) Filed: Dec. 20, 2011

(51) Int. Cl. H04N 5/222

(52) U.S. Cl. 348/333.05; 348/E05.024; 348/E05.056

(57) ABSTRACT

Methods, apparatus, and computer readable media enhance details in a preview image for an imaging device. In one method, an image of a scene is captured with an image sensor, one or more objects of interest may be detected in the scene, a window layout for a preview window can be displayed, a composite image is generated, the composite image is displayed on a preview display. The composite image may include the captured scene along with an enhanced detail window containing the object of interest. The object of interest may be a face. The apparatus may include a touch screen display, with the position or size of the enhanced detail window changeable via gesture inputs detected on the touchscreen display. Which object of interest is displayed in the detail window may be changed from one object of interest to another through gesture inputs.

### TECHNICAL FIELD

The present embodiments relate to imaging devices, and in particular, to methods, and apparatus for the capture and enhancement of digital images.

### BACKGROUND

While dedicated digital cameras have existed for some time, it is only in the past decade that digital imaging capabilities have also been integrated into a wide range of other devices. These devices include laptop computer monitors, tablets, pdas, and mobile phones. As digital imaging capabilities have become ubiquitous on these platforms, the convenience associated with the embedded imaging capabilities on mobile platforms have led users to utilize these devices for a wide variety of imaging tasks. While these integrated cameras were originally conceived as a convenience item, their use has migrated to higher quality imaging tasks. In some cases, users may forgo purchasing dedicated digital cameras, and rely instead on a camera embedded in another mobile device.

Many of these digital imaging devices include a “preview” mode, providing a real time image taken from an imaging sensor and displayed on an electronic display. This “preview” image augments or replaces a traditional optical “viewfinder” on more traditional imaging devices. One role of the preview window may be to allow a photographer to determine the appropriate framing for the image they desire to capture. The boundaries of the preview image communicate to the photographer which portion of a scene will be included in their photograph or movie and which portion will not. Not unlike a traditional viewfinder image, it may also communicate the particular orientation or content of the frame itself.

While the preview image may be replacing the traditional optical viewfinder, it still retains some of its inherent disadvantages. For example, the photographer's ability to frame an entire image while also perceiving fine details within the image may be limited. A digital imaging device's imaging sensor may capture a high resolution image including fine details needed by the photographer, but because the image's resolution is reduced to fit within the preview window, those details may be lost.

This problem may become more severe when capturing an image that includes large backgrounds. For example, framing an image that includes a large landscape in the background with a person or animal close to the imaging device in the foreground may result in a loss of detail in the person or animal as seen in the viewfinder or preview image. While the detail may be captured by the imaging sensor, the need to display the entire background landscape in the preview window may result in the image being scaled to fit, with a corresponding reduction in image resolution.

Thus, traditional viewfinders and now preview images fail to adequately communicate both image framing information and detailed information to a photographer before an image is captured. This failure ultimately results in less satisfaction for the photographer and lower quality images in some circumstances.

### SUMMARY

Some of the present embodiments may comprise a method of providing a preview window in a digital imaging device. The method may comprise capturing a digital image of a scene with an imaging sensor. The method may further comprise detecting a first object of interest in the digital image, and displaying a combined image comprising at least a portion of the digital image at a first scale and at least a portion of the object of interest at a second scale on an electronic display on the electronic display, wherein the second scale is larger than the first scale. This method may be performed repetitively, in some embodiments at a rate of at least five times per second.

In some embodiments, the object of interest may be a face. Some embodiments may detect a second object of interest in the digital image. Other embodiments may display at least a portion of the second object of interest at the second scale simultaneously with the display of the at least a portion of the first object of interest on the electronic display. Some embodiments may instead display the second object of interest at a third scale.

Some embodiments may switch between displaying the at least a portion of the first object of interest at a second scale and displaying the at least a portion of the second object of interest at a second scale. In some embodiments, the object of interest is displayed within a window or rectangle overlaid on a portion of the digital image. Some embodiments may change the position of the at least a portion of the object of interest on the electronic display. For example, if an object of interest is displayed in a detail window, the detail window may be repositioned via a touch gesture on a touch screen display. Some embodiments also include changing the scale of the at least a portion of the object of interest in the detail window. Changing the scale may also be performed via a touch gesture on a touch screen display.

Some embodiments further comprise selecting the at least a portion of the first object of interest for display based on the relative distance of each object of interest from a center of the scene. Other embodiments may further comprise selecting the at least a portion of the first object of interest for display based on the relative size of the first object of interest compared to the second object of interest. In other embodiments, the selecting of the object of interest is based on a configurable parameter.

Some operative embodiments include an apparatus comprising an imaging sensor, an electronic display, an imaging sensor control module configured to capture a digital image of a scene with an imaging sensor, an object of interest detection module configured to detect a first object of interest in the digital image, and a window display module configured to display a combined image comprising at least a portion of the digital image at a first scale and at least a portion of the first object of interest at a second scale, wherein the second scale is larger than the first scale. In some embodiments, the control module is further configured to perform these elements repetitively. In some embodiments, the object of interest is a face, an insignia, or text. In other embodiments, the object of interest is an aircraft. In other embodiments, the object of interest may be a human figure. In still other embodiments, the object of interest may be an animal. In other embodiments, the object of interest may be a moving object.

In some embodiments, the object of interest detection module will be configured to also detect a second object of interest in the digital image. The window display module may be configured to display at least a portion of the second object of interest at the second scale simultaneously with the display of the at least a portion of the first object of interest on the electronic display. Some embodiments may allow the display to be switched between at least a portion of the first object of interest in a detail window and a at least a portion of the second object of interest in the detail window. In some embodiments, the object of interest is displayed within a rectangle or window appearing to be overlaid on the preview image on the electronic display. In other embodiments, the apparatus may further comprise a touch screen input module configured to detect a touch gesture on the display. In some embodiments, the apparatus is a wireless telephone.

Some embodiments of the apparatus may include a touch screen display. In some of these embodiments, the touch screen input module may be further configured to detect a touch gesture on the display. In some embodiments, the touch screen input module may be further configured to change the position of a detail window or portion of the object of interest on the electronic display in response to detecting a touch gesture on the touch screen display. In some embodiments, the touch screen input module may be further configured to change the scale of the object of interest in response to the detection of a gesture input on the touch screen display.

Other present embodiments may include a non-transitory computer readable medium containing processor executable instructions that are operative to cause a processor to capture a digital image of a scene with an imaging sensor, detect a first object of interest in the digital image, and display a combined image comprising at least a portion of the digital image at a first scale and at least a portion of the object of interest at a second scale, wherein the second scale is larger than the first scale. In some of these embodiments, the object of interest is a face, an insignia, or text. In some embodiments, the computer readable medium further comprises instructions that when executed cause a processor to detect a second object of interest in the digital image.

Other present embodiments include imaging apparatus comprising a means for capturing a digital image of a scene with an imaging sensor, means for detecting a first object of interest in the digital image, and means for displaying a combined image comprising at least a portion of the digital image at a first scale and at least a portion of the object of interest at a second scale, wherein the second scale is larger than the first scale. In some embodiments, the object of interest is a face, an insignia, or text. Some embodiments further comprise a means for detecting a second object of interest in the digital image.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 is a block diagram depicting a device implementing some operative embodiments. The major components of an imaging device are illustrated.

FIG. 2A illustrates a traditional preview image for an imaging sensor integrated into a mobile device.

FIG. 2B illustrates an image preview window in an imaging device implementing one operative embodiment that includes an expanded detail window of an object of interest.

FIG. 3 illustrates one possible implementation of an image pipeline that supports a preview window that includes a detail window.

FIG. 4 is a flow chart depicting a process utilized in one embodiment of a preview control module.

FIGS. 5A-C illustrate an image preview window implementing one operative embodiment including an ability to select a second object of interest for an expanded detail window using a touch gesture.

FIGS. 6A-C illustrate an image preview window implementing one operative embodiment including an ability to select a second object of interest and open a second detail window using a touch gesture.

FIG. 7 illustrates one embodiment of a process utilized to receive touch input and correlate the location of the touch input with particular objects of interest.

FIG. 8 illustrates one embodiment of a process utilized to capture multiple image frames from an imaging sensor and correlate the objects of interest between image frames.

FIG. 9 illustrates an image preview window implementing one operative embodiment including an ability to move an expanded detail window using a touch gesture.

FIGS. 10A-B illustrate an image preview window implementing one operative embodiment including an ability to resize an expanded detail window using a touch gesture.

FIG. 11 is a flowchart illustrating one operative embodiment of a method implementing move and resize operations as illustrated in FIGS. 9-10.

### DETAILED DESCRIPTION

Implementations disclosed herein relate to an image preview enhancement methods and apparatus for displaying a preview window on a display of a digital imaging device. One embodiment is a system or method for capturing a digital image of a scene and detecting a first object of interest in the digital image. For example, the object of interest may be a detected face of a person in the captured image. In this embodiment, the system may display a portion of the digital image at a first scale and at least a portion of the object of interest at a second scale on the electronic display. Thus, a detected face within the digital image may be presented in an increased scale and overlaid on the captured scene image so that the user can review the facial features of one or more faces within the captured image. In this example, the user could review the facial features at the increased scale to see if a person in the image was smiling, frowning, or making other facial gestures within the captured image. One skilled in the art will recognize that these embodiments may be implemented in hardware, software, firmware, or any combination thereof.

In the following description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

As described earlier, traditional viewfinders and preview images suffer from an inability to provide satisfactory information to photographers under certain conditions. This is at least partially due to the inability of some systems to convey information about how an image is framed and while also providing small detailed information within the image. Such information may be necessary for a photographer to capture a high quality image. In one embodiment, the photographer may first frame an image based on the background features they wish to include in the image. Then, the photographer may desire to observe a person in the foreground until the person presents a perfect smile. By using embodiments of the invention, a preview image that simultaneously communicates framing information and detailed information is generated. For example, the display may show in real-time the currently imaged scene, but also have an overlaid, scaled window showing the facial features of one or more subjects in the scene so that the photographer can determine if everyone has the proper smile prior to capturing the image. The disclosed methods and apparatus enable this capability by continuing to provide the broader image information needed to adequately frame the image within the preview window, while also providing detailed information for particular objects of interest in a second window within the preview image. In some embodiments, the detailed information for particular objects is presented at a different scale than the broader framing image information.

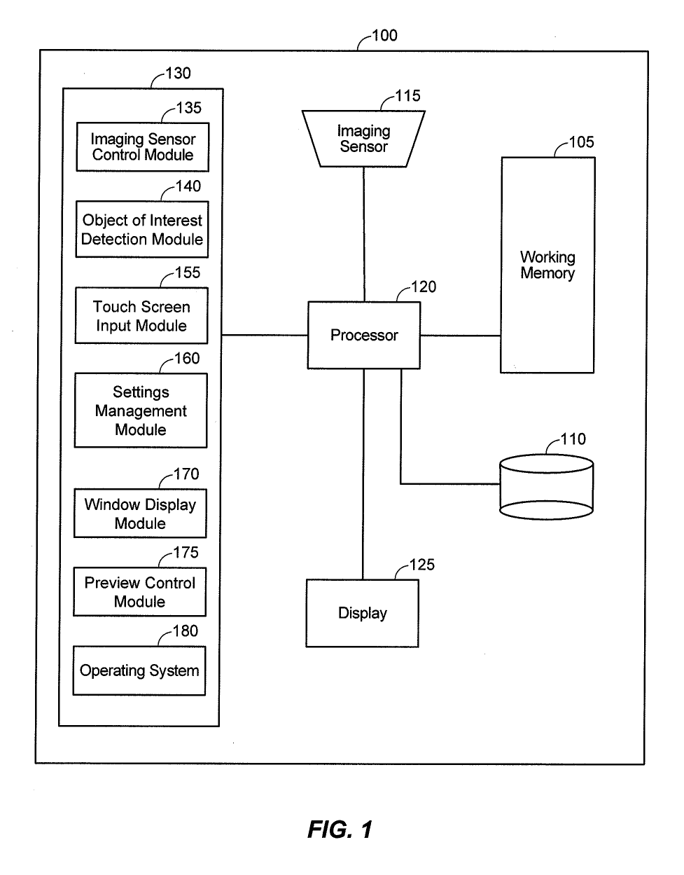

FIG. 1 depicts a high-level block diagram of a device 100 having a set of components including a processor 120 linked to an imaging sensor 115. A working memory 105, storage 110, electronic display 125, and memory 130 are also in communication with the processor 120.

Device 100 may be a cell phone, digital camera, personal digital assistant, or the like. Device 100 may also be a more stationary device such as a desktop personal computer, video conferencing station, or the like. A plurality of applications may be available to the user on device 100. These applications may include traditional photographic applications, high dynamic range imaging, panoramic video, or stereoscopic imaging such as 3D images or 3D video.

Processor 120 may be a general purpose processing unit or a processor specially designed for imaging applications. As shown, the processor 120 is connected to a memory 130 and a working memory 105. In the illustrated embodiment, the memory 130 stores an imaging sensor control module 135, object of interest detection module 140, touch screen input module 155, settings management module 160, window display module 170, preview control module 175, and operating system 180. These modules include instructions that configure the processor to perform various image processing and device management tasks. Working memory 105 may be used by processor 120 to store a working set of processor instructions contained in the modules of memory 130. Alternatively, working memory 105 may also be used by processor 120 to store dynamic data created during the operation of device 100.

As mentioned above, the processor is configured by several modules stored in the memories. The imaging sensor control module 135 includes instructions that configure the processor 120 to adjust the focus position of imaging sensor 115. The imaging sensor control module 135 also includes instructions that configure the processor 120 to capture images with imaging sensor 115. Therefore, processor 120, along with image capture control module 135, imaging sensor 115, and working memory 105 represent one means for capturing an image using an imaging sensor. The object of interest detection module 140 provides instructions that configure the processor 120 to detect an object of interest in the images captured by imaging sensor 115. In some embodiments, an object of interest may be a human face. Touch screen input module 155 may include instructions that configure the processor 120 to receive touch inputs from a touch screen display, for example, display 125. Settings management module 160 may include instructions to manage various parameter settings for device 100. For example, parameters related to the configuration of the preview window may be managed by module 160. Window display module 170 may include instructions to manage the layout of data within the preview window generated on display 125 within device 100. For example, the preview window may include more than one image “window” within it. Some “windows” may display data at differing scales. Instructions within window display module 170 may configure the processor to translate data related to each of these sub windows into display commands for display 125.

Preview control module 175 includes instructions that configure the processor to display a preview window on electronic display 125 according to the methods described above. For example, preview control module 175 may include instructions that call subroutines in imaging control module 135 in order to configure the processor 120 to capture a first image using imaging sensor 115. Preview control module 175 may then call object of interest detection module 140 to detect objects of interest in a first image captured by imaging sensor 115. Instructions in preview control module may then invoke settings management module 160 to determine how the operator has configured the preview window to display on display 125. This information may be provided to window display module 170, in order to layout the preview window as configured using the image data captured by imaging sensor 115 and the object of interest information determined by object of interest detection module 140. Window display module 170 may invoke instructions in operating system 180 to control the display and cause it to display the appropriate preview window configuration on electronic display 125.

Operating system module 180 configures the processor to manage the memory and processing resources of device 100. For example, operating system module 180 may include device drivers to manage hardware resources such as the electronic display 125, storage 110, or imaging sensor 115. Therefore, in some embodiments, instructions contained in the preview image processing modules discussed above may not interact with these hardware resources directly, but instead interact through standard subroutines or APIs located in operating system component 180. Instructions within operating system 180 may then interact directly with these hardware components.

Processor 120 may write data to storage module 110. While storage module 110 is represented graphically as a traditional disk device, those with skill in the art would understand multiple embodiments could include either a disk based storage device or one of several other type storage mediums to include a memory disk, USB drive, flash drive, remotely connected storage medium, virtual disk driver, or the like.

Although FIG. 1 depicts a device comprising separate components to include a processor, imaging sensor, and memory, one skilled in the art would recognize that these separate components may be combined in a variety of ways to achieve particular design objectives. For example, in an alternative embodiment, the memory components may be combined with processor components to save cost and improve performance.

Additionally, although FIG. 1 illustrates two memory components, to include memory component 130 comprising several modules, and a separate memory 105 comprising a working memory, one with skill in the art would recognize several embodiments utilizing different memory architectures. For example, a design may utilize ROM or static RAM memory for the storage of processor instructions implementing the modules contained in memory 130. Alternatively, processor instructions may be read at system startup from a disk storage device that is integrated into device 100 or connected via an external device port. The processor instructions may then be loaded into RAM to facilitate execution by the processor. For example, working memory 105 may be a RAM memory, with instructions loaded into working memory 105 before execution by the processor 120.

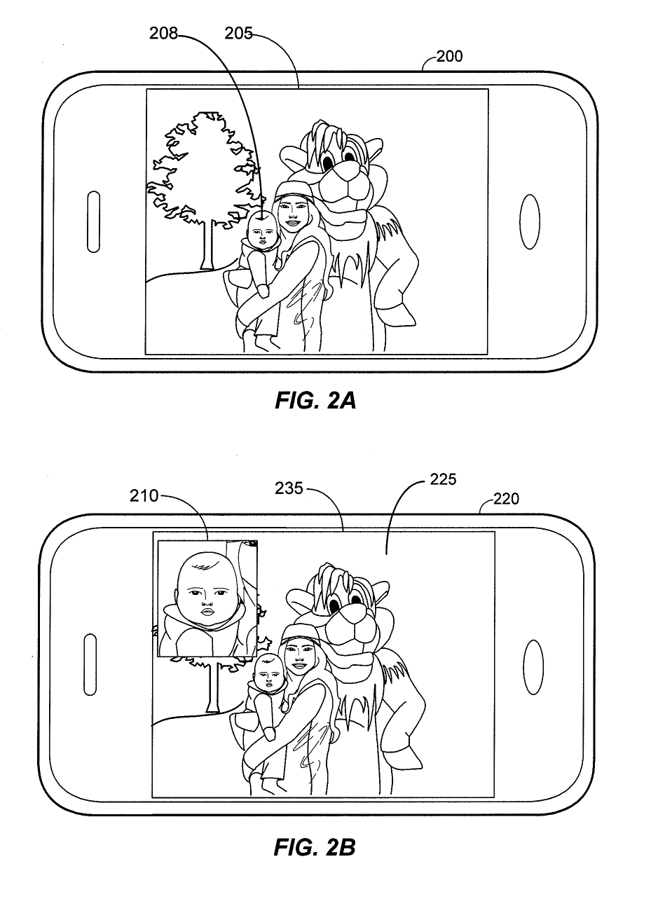

FIG. 2A illustrates a traditional preview image 205 for an imaging sensor integrated into a mobile device 200. As illustrated, the preview image 205 provides a view of how a captured image will appear. The preview image 205 is displayed at a single scale. Because the entire image is visible, the photographer is able to easily frame the image to include the particular content they wish to include in the captured image. However, because all of the content is at a single scale, it may be difficult to observe particular details in the image before capturing the image. For example, a baby's face 208 in the preview image 205 may be difficult to observe closely before image capture, especially given that many photographers hold the imaging device at some distance from their eyes, and they tend to introduce some amount of hand shake into the device, which also makes fine details in the preview image harder to perceive before an image is captured.

FIG. 2B shows a mobile device 220 that includes an embodiment of an image preview enhancement system as described herein. A preview image 225 is shown as presented on a display 235 and continues to show most of the image as captured by the imaging sensor. However, a detail window 210 is generated in the top left corner of the preview image 225. The detail window 210 includes the baby's face at a larger scale to enable the photographer to observe the baby's face more easily when determining the best image to capture. While the detail window 210 is illustrated in the top left corner in FIG. 2B, one with ordinary skill in the art would recognize that the detail window 210 may be positioned by default or via user input anywhere within the preview image. In order to avoid overlaying important image data with the detail window, some embodiments may include methods to detect the least interesting portion of the preview image 205. For example, the detail window 210 may be automatically positioned in areas of the preview image 205 that contain relatively consistent image data. Large areas of sky in an image (not shown), for example, may be automatically set as default locations for one or more preview windows.

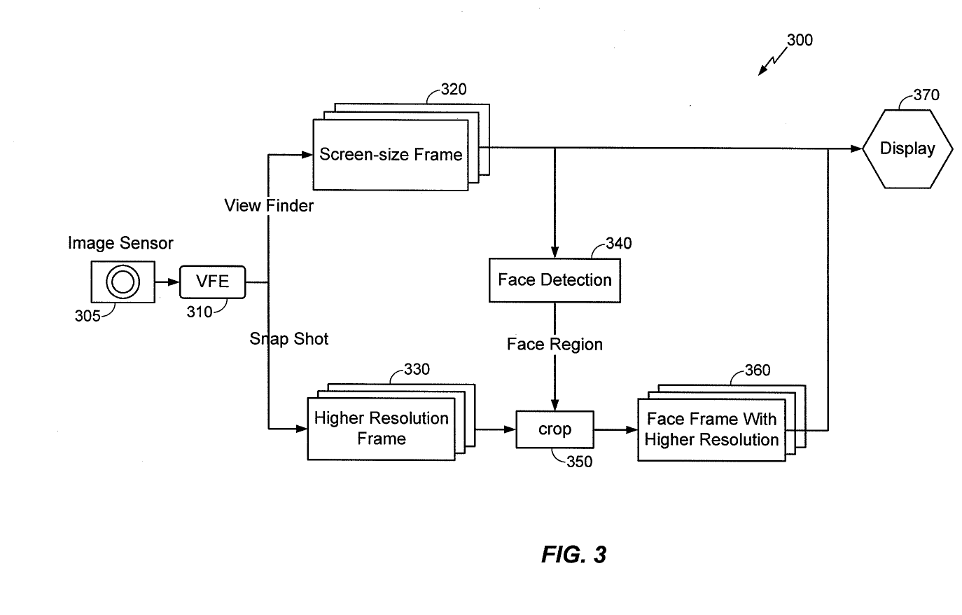

FIG. 3 illustrates one implementation of an image pipeline 300 that supports a real time image preview window with one or more detail windows, as illustrated in FIG. 2b. The pipeline 300 begins with an image sensor 305. Images captured by the image sensor 305 are fed into a video frame engine (VFE) 310. The video frame engine 310 produces two series of frames, one that consists of higher resolution frames series 330 suitable for recording image snapshots. The other frame series 320 is scaled to fit on an electronic display used by the device for a preview window. This scaled series of frames 320 may be at a lower resolution than the higher resolution frames 330, so as to be compatible for display on a display 370. The scaled frames are sent to the electronic display 370 to be displayed. In the illustrated embodiment, a face detection unit 340 also receives the scaled screen size frames 320 as input. The face detection unit 340 determines face locations within the screen size frame and sends location information to a crop unit 350. The crop unit 350 also receives the high resolution frames 330 from the video frame engine 310. By correlating the face locations from the lower resolution screen size frames to the higher resolution frames, the crop unit may crop the higher resolution frames so as to include only the face(s) of interest, but at a high resolution. This cropped high resolution frame is sent to the display 370 and may be used to produce a detail window as illustrated in FIG. 2.

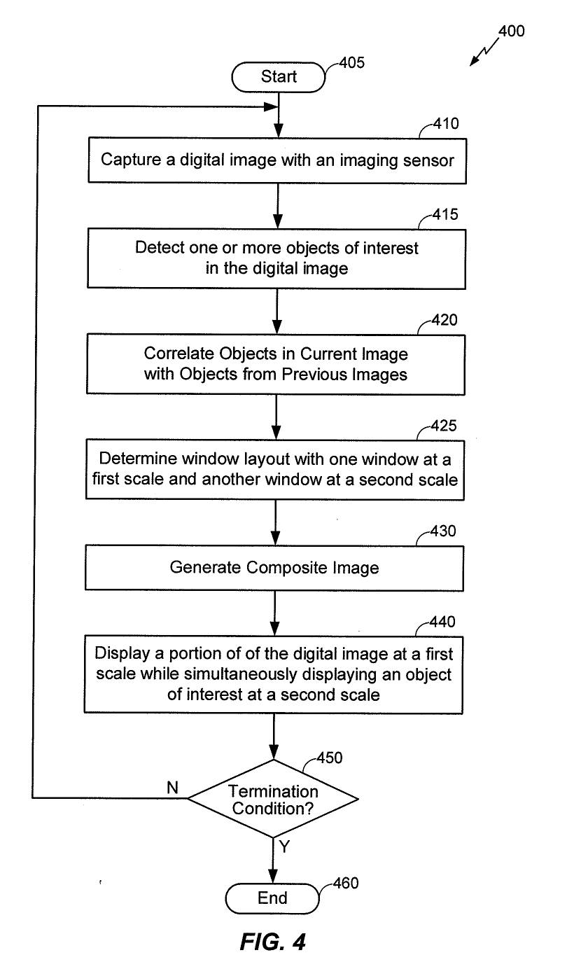

FIG. 4 is a flow chart illustrating a process 400 that runs within one embodiment of the preview control module 175 of FIG. 1. The process 400 begins at start block 405 and then transitions to block 410 where a digital image is captured with an imaging sensor. Block 410 may be implemented by instructions in preview control module 175 calling subroutines inside imaging sensor control module 135. Imaging sensor control module 135 may then configure the processor to control imaging sensor 115, possibly via operating system module 180, to capture an image. Therefore, instructions in the preview control module and imaging sensor control module represent one means for capturing a digital image of a scene with an imaging sensor.

Process 400 then moves to block 415 where one or more objects of interest are detected in the digital image. Block 415 may be implemented by instructions contained in the object of interest detection module 140 of device 100, illustrated in FIG. 1. In some embodiments of process 400, the object of interest may be a face. Several face detection algorithms are known in the art. For example, the Viola-Jones object detection framework may provide object detection at real-time rates. This algorithm is implemented in the Open Source Computer Vision Library (OpenCV) as cvHaarDetectObjects( ). Other techniques are also known, including the Eigenfaces algorithm, and the combined PCA and LDA algorithm. The disclosed methods and apparatus may operate with any face detection method that can provide results within a timeframe acceptable to a user. Therefore, instructions contained in an object of interest detection module 140 implementing a face detection method represent one means for detecting an object of interest in a digital image.

Other types of objects of interest are also contemplated. For example, animal faces may be identified. Other embodiments may detect entire animals within a scene. For example, a wildlife photographer may wish to photograph grizzly bears on an Alaskan tundra. Such images may include an Alaskan landscape in the preview window, with the bear identified as an object of interest. Special processing of the bear's image may then be provided as part of the preview image. For example, the entire bear may appear in a detail window on the preview image.

Alternatively, moving objects may be identified as objects of interest by the object of interest detection module 140. Photographers may wish to see a moving object in greater detail before capturing a photo. In embodiments tailored to these photographers, block 415 may employ methods to detect objects moving within a frame as objects of interest, and provide for special processing of those objects as part of the preview image. These embodiments may be useful in photographing sports activities for example. Therefore, instructions in an object of interest module configured to detect moving objects within an image may represent another means for detecting an object of interest in the digital image.

Security camera operators may also have a particular interest in moving objects. A security officer monitoring a remote road may wish to gather enhanced detail on an automobile license plate for example. Therefore, instructions in an object of interest module configured to detect automobile license plates may represent another means for detecting an object of interest in the digital image.

Other embodiments may include an object of interest detection module that includes instructions configured to detect an image of a driver behind an automobile steering wheel. Face detection technology can then be employed to provide identification information for the driver to the officer.

Military applications are also contemplated. For example, military optical systems may detect human silhouettes or figures as objects of interest in an acquired image. By enhancing the detail of human figures, viewers may be aided in identifying uniforms, weapons, or specific activity of these figures. Such information can be of great assistance in IFF (Identification Friend or Foe) at extended ranges. For example, a sniper scope may be enabled to provide a large field of view along with enhanced detail of potential targets, easing the workload on snipers or their spotters. Therefore, instructions in an object of interest module configured to detect human figures or silhouettes may represent another means for detecting an object of interest in the digital image.

The specific objects recognized as an object of interest may also be user configurable. For example, some embodiments may allow the operator to provide one or more example images to the object of interest detection module. Via a variety of means known in the art, the operator may indicate a specific object of interest within the example images. The object of interest detection module may then use pattern matching algorithms or other techniques known in the art to detect objects of interest in new images that resemble the objects of interest identified by the operator in the example images.

After the object(s) of interest have been detected in block 415, process 400 then moves to block 420 to correlate objects of the current image with objects of previous images. To present the appearance of a continuous real time display, a preview image may be implemented via an iterative cycle of image capture/process/display. When this cycle is repeated more frequently than the human eye can detect, the image may appear continuous to most observers. To ensure a consistent representation of objects of interest within this iterative image capture/process/display environment, some embodiments may include block 420, which correlates objects of interest between multiple image frames, which may ensure consistent and smooth display of objects of interest to the user across image frames. Block 420 is optional and may not be implemented by all embodiments. For example, embodiments that do not capture video may not require block 420.

After objects of interest in the current frame have been correlated with any objects of interest from previous frames, process 400 moves to block 425, where the window layout of the preview image is determined. Block 425 may be implemented by instructions contained in the window display module 170 of device 100. As illustrated in FIG. 2B, preview images utilizing embodiments of the invention may include at least two images. In FIG. 2B, the two images are the large image that occupies a majority of the preview image display area, and includes the baby, woman, lion, and surrounding plants. The second image is located in the top left corner of the preview image, and includes a detailed view of the baby's face. Each of these images may be referred to as a window by those of ordinary skill in the art. In block 425, the display attributes of each window are determined. For example, the position of each window in the preview window may vary, depending on how the imaging device is configured, how many objects of interest are detected in the scene, or other variables. Block 425 will determine the appropriate position for each window given at least these parameters. The size and content of each window may also vary. For example, using FIG. 2B as an example, while the baby's face is illustrated in the second window, the detail window's content might include the woman's face instead. Instructions within block 425 may also determine these attributes. Finally, the scale of each window may vary. For example, the content of one window may be at a first scale while the content of a second window may be at a second scale. Block 425 accounts for these variations to determine how the windows and the image data they contain should be laid out to construct the preview window.

Process 400 then moves to block 430, where a composite image is generated. Block 430 may be implemented by instructions included in window display module 170 or preview control module 175. Block 430 may receive as input at least the data indicating the content of each window to be displayed and data indicating the window layout as determined by block 425. Based on this data, block 430 may generate a composite image that meets the requirements for display on a display device, for example, display 125 of device 100, illustrated in FIG. 1. Therefore, instructions included in a window display module and/or a preview control module, configured to determine what data each window contains and how each window should be displayed comprise one means for displaying a combined image comprising at least a portion of the digital image at a first scale and at least a portion of the object of interest at a second scale on an electronic display, wherein the second scale is larger than the first scale on an electronic display.

Process 400 then moves to block 440, where the composite image is displayed. The composite image may include a portion of the digital image at a first scale and a portion of the object of interest at a second scale. Block 440 may be implemented by instructions included in any of the window display module 170, preview control module 175, or operating system 180.

One with skill in the art would recognize multiple equivalent methods to display a portion of a digital image at a first scale while also displaying an object of interest at a second scale. For example, while process 400 illustrates the generation of a composite image that includes a portion of the digital image and an object of interest, other embodiments may not explicitly form a composite image. For example, some embodiments may utilize video drivers that may display data from physically disparate memory locations, reducing the need for a contiguous composite image. With these embodiments, the digital image data at a first scale and another image including an object of interest at a second scale may exist at separate memory locations, with the address of each location passed to a video driver, which then renders the images on an electronic display.

After the digital image and the object of interest are displayed, process 400 then moves to decision block 450, where it is determined if any termination conditions have been reached. If no termination conditions have been reached, process 400 returns to block 410 where another image is captured. Process 400 then repeats. Termination conditions can include many different types of events. For example, a signal by the user to capture an image, such as a shutter release, may terminate process 400. Powering the device off may also terminate process 400. The user may also indicate via a device user interface that they intend to utilize the preview display for alternative tasks, for example, configuring imaging parameters. This may disable the preview windowing capability of the device and thus terminate process 400 at decision block 450. Once a termination condition has been detected, process 400 moves to end state 460.

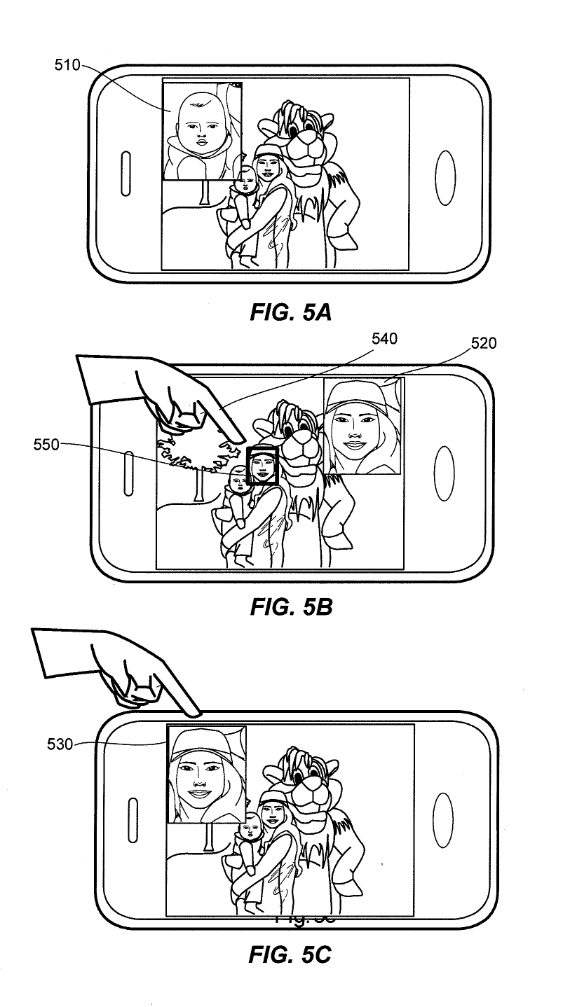

FIGS. 5A-C illustrate an image preview window implementing one operative embodiment including an ability to select a second object of interest for an expanded detail window using a touch gesture. As illustrated in FIG. 5A, the baby's face is an object of interest and is displayed in the detail window 510. As shown in FIG. 5B, a finger 540 may be used to select a woman's face 550 in the illustrated embodiment. Upon this selection, the detail window 520 displays the woman's face. It should be noted that the embodiment illustrated in FIG. 5B also relocates the detail window 520 to the opposite side of the display. However, other embodiments may maintain the existing position of the detail window and simply replace the first object of interest's image with the new object of interest, as illustrated in FIG. 5C.

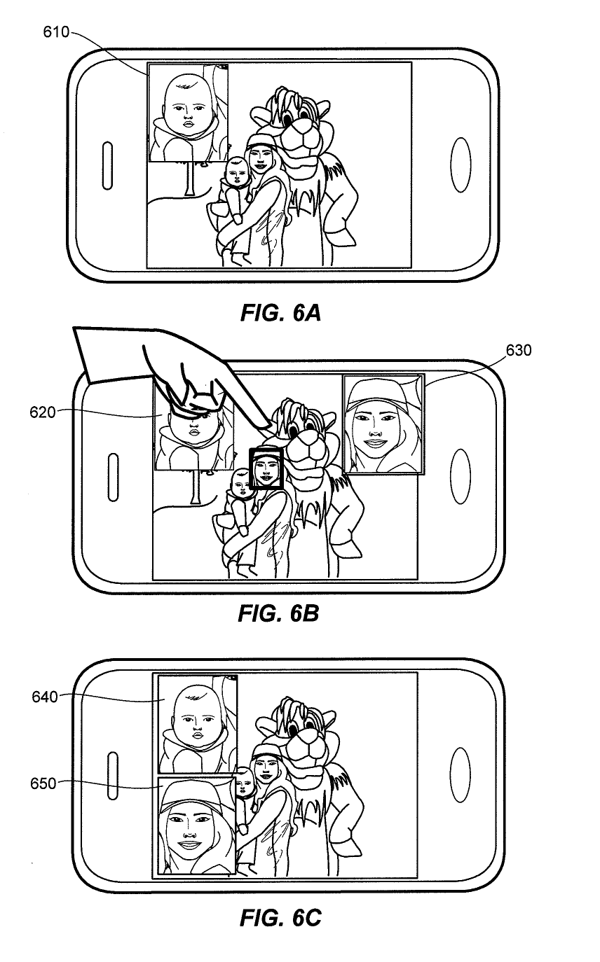

FIGS. 6A-C illustrate an image preview window implementing one operative embodiment including an ability to select a second object of interest for an expanded detail window using a touch gesture, where the illustrated device supports multiple detail windows simultaneously. As can be observed in FIG. 6A, the baby's face is illustrated as an object of interest and is also displayed in a first detail window 610. As shown in FIG. 6b, by touching the woman's face in the illustrated embodiment, a new detail window 630 for the woman's face is opened. While the embodiment illustrated in FIG. 6B locates the new detail window in the upper right corner of the preview image, other embodiments may choose to locate the new detail window differently. For example, some embodiments may display detail windows in a column on the left (or right) side of the image, as illustrated by FIG. 6C with detail windows 640 and 650. Alternatively, the detail windows may be displayed in a row at either the top or bottom of the preview window display.

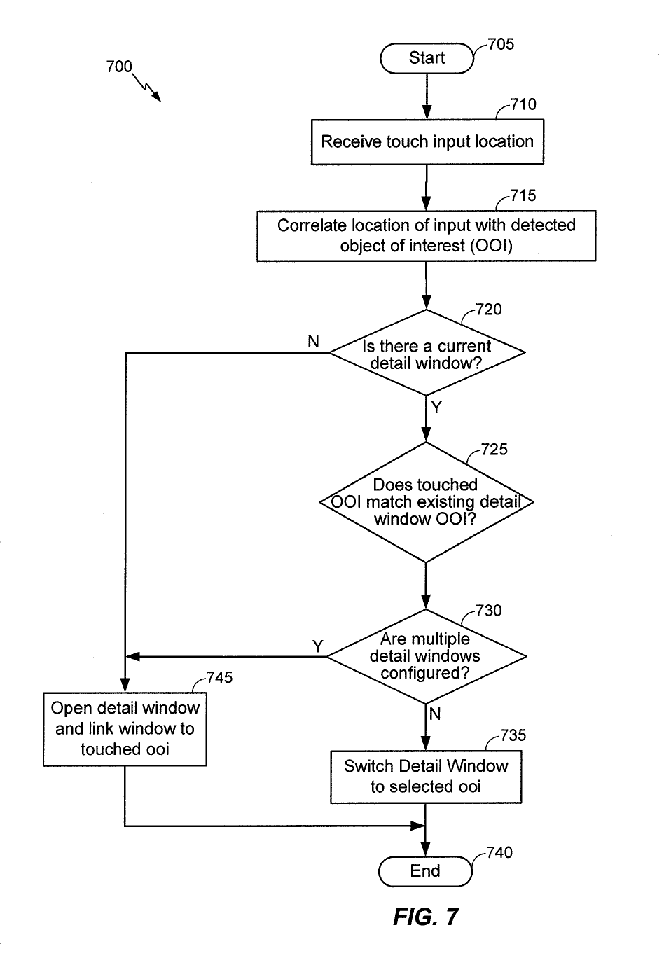

FIG. 7 illustrates one embodiment of a process utilized to determine which objects of interest are displayed in which detail windows of the preview image, for example, the preview windows illustrated in FIGS. 5 & 6. Process 700 of FIG. 7 begins at start block 705 and then moves to block 710 where a touch input location is received. Block 710 may be implemented by instructions included in the touch screen input module 155 of device 100, illustrated in FIG. 1. Process 700 then moves to block 715 where the location of the touch gesture is correlated to the locations of any detected object of interest (OOIs) of the current image frame. Process 700 then moves to decision block 720, where it is determined whether there are currently any detail windows displayed as part of the preview image. Block 720 may be implemented by instructions included in the preview control module 175 of device 100, illustrated in FIG. 1. If not, process 700 moves to block 745 where a new detail window is opened and linked to the touched object of interest. Block 745 may be implemented by the preview control module 175 calling subroutines in the window display module 170 or operating system module 180 of device 100, illustrated in FIG. 1. Process 700 then transitions to end block 740. If there currently is a detail window open at decision block 720, process 700 moves to decision block 725 where it is determined whether the touched object of interest is currently displayed in the detail window. Block 725 may also be implemented by the preview control module 175 of device 100. If not, process 700 moves to decision block 730, where it is determined whether multiple detail window support is enabled. Block 730 may be implemented by the preview control module 175 of device 100 calling subroutines in the settings management module 160. If multiple detail windows are enabled, process 700 moves to block 745 and an additional detail window is opened and linked to the selected object of interest. Process 700 then moves to end state 740. If multiple detail windows are not configured, process 700 moves to block 735, where the existing detail window is switched from its previous object of interest to the new selected object of interest.

Note that while process 700 illustrates an embodiment where objects of interest are selected via touch gestures, one with ordinary skill in the art would understand other embodiments may provide alternate means for an object of interest to be displayed in a detail window. For example, objects of interest may be automatically selected based on their size or position within the preview window.

Furthermore, although FIG. 7 illustrates an embodiment that unconditionally opens detail windows when a new object of interest is selected, one with ordinary skill in the art would understand that some embodiments may include additional processing logic to manage the maximum number of detail windows, and the object of interests displayed within them. For example, some embodiments may limit the number of detail windows to a fixed number, for example, three. Alternatively, other embodiments may limit the number of detail windows based on the memory of the device or available screen space.

Similarly, although not described by FIG. 7, one with skill in the art would recognize that some embodiments of the method and apparatus disclosed would include an ability to close detail windows. For example, touch gestures may be defined that when detected, close a detail window. Alternatively, devices including traditional pointing devices may utilize techniques known in the art to provide for a close operation on a detail window. For example, right clicking on a detail window may provide a pop up menu that includes a “close” command. Alternatively, each detail window may include icons positioned either along its border or within the window itself, that when selected via either a touch gesture or a pointing device, facilitate closing of the detail window.

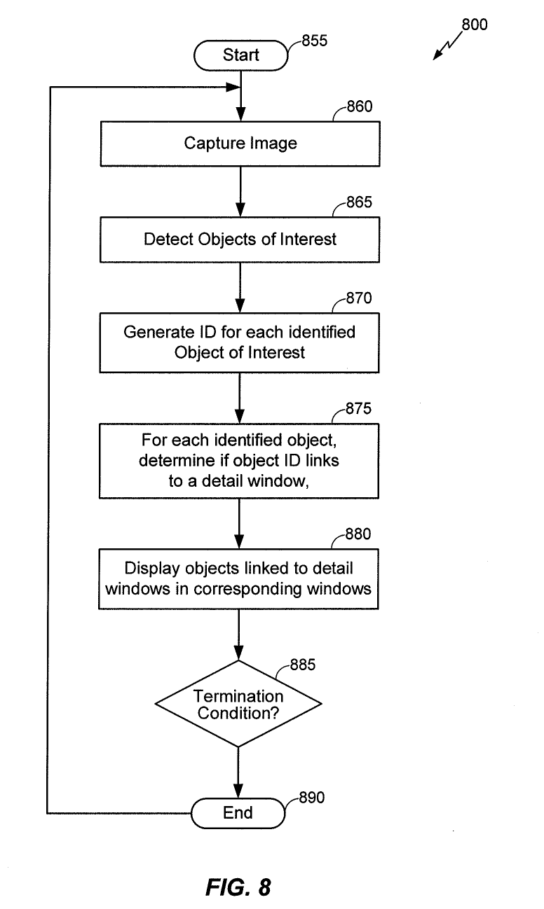

FIG. 8 illustrates one embodiment of a process utilized to capture multiple images from an imaging sensor and correlate the objects of interest between frames. Process 800 begins at start block 855 and then moves to block 860 where an image is captured. Block 860 may be implemented by instructions included in the image sensor control module 135 or the preview control module 175 of device 100, or a combination of instructions from these two modules configured to work together. After the image has been captured, process 800 then moves to block 865. In block 865, objects of interest within the captured image are detected. A variety of objects of interest may be detected as discussed previously. Block 865 may be implemented by instructions included in the object of interest detection module 140 of device 100, illustrated in FIG. 1. Next, process 800 moves to block 870, where an identifier is generated for each identified object of interest. In order to correlate objects of interest between images, process 800 must generate an identifier for each object of interest that will generally remain constant as long as that object remains part of the image being captured by the imaging sensor. The consistency of this identifier will allow additional processing performed later to properly identify the same object of interest across image frames, even if the object changes position within the image frame. Generation of an object identifier may be performed by instructions included in the object of interest detection module 140 of device 100.

Next, process 800 moves to block 875 where it is determined whether each identified object of interest is linked to an active detail window. Block 875 may be performed by instructions in the preview control module 175 Process 800 then moves to block 880, where objects of interest that are linked to a detail window are displayed in the corresponding detail window on the preview image. Process 800 then moves to block 885 where termination conditions are checked. Termination conditions for process 800 may include a power off event, a shutter release, or a command that configures the imaging device to utilize the display for another purpose. If no termination condition is present, process 800 returns to block 860 where another image is captured and the process repeats. If a termination condition is detected, process 800 then moves to end state 890.

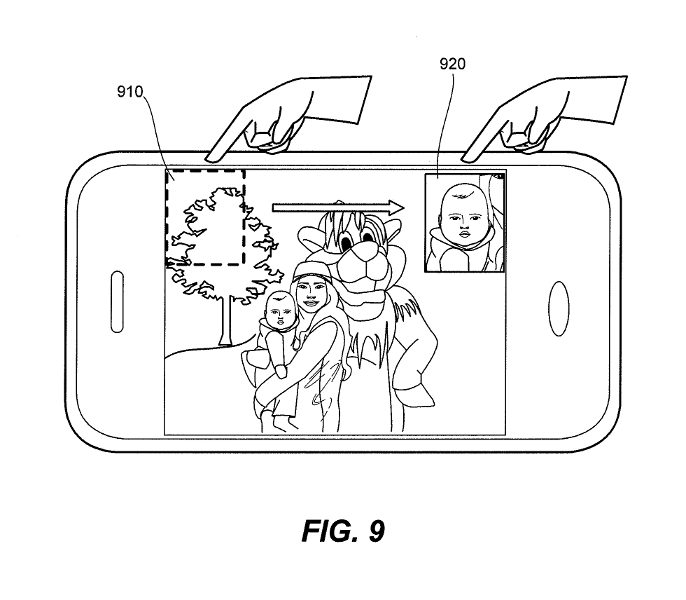

FIG. 9 illustrates an imaging device 100 including a preview window implementing one operative embodiment including an ability to move a detail window using a touch gesture. As previously discussed, embodiments of the methods and apparatus disclosed may provide a default location for one or more detail windows. Some embodiments may also provide the ability for the user to modify the location of one or more detail windows. For example, as illustrated in FIG. 9, touch gesture inputs may enable a user to drag a detail window from one location 910 within the preview image to another location 920. Other embodiments may provide for the movement of the detail window through a series of tap gestures.

When multiple detail windows are displayed, the amount of available preview image area is more constrained. Thus, the likelihood that a detail window obscures important information in the preview window increases. Providing the ability to move the multiple detail windows via drag gestures can improve the ease of use of the device.

Some embodiments may provide still other means to reposition the detail window. For example, devices that include arrow keys may define the arrow keys so as to facilitate movement of the detail window. Devices incorporating mice, mouse pads, track balls, or similar pointing devices may employ a standard click and drag paradigm to enable repositioning of the detail window.

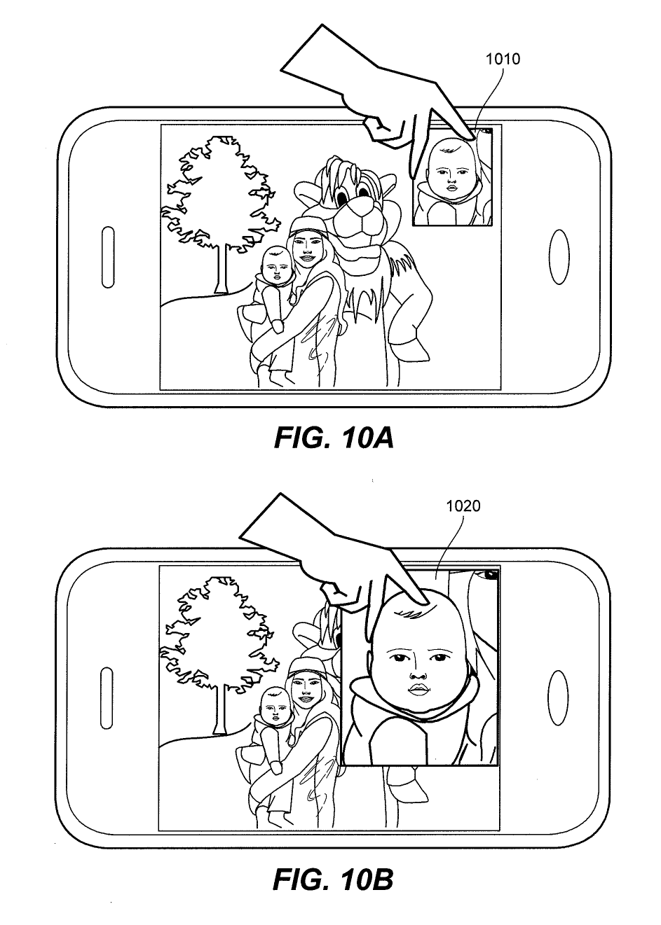

FIGS. 10A-B illustrate an imaging device including a preview window illustrating one operative embodiment of an ability to resize a detail window 1010 using a touch gesture. Some operative embodiments may utilize the pinch gesture to resize the detail window as shown. By resizing the detail window, the scale at which the object of interest is displayed is also changed relative to its scale before the resize operation. This change in the detail window size and scale of the object of interest is illustrated by detail window 1020, which, as illustrated, is the result of resizing detail window 1010.

In some embodiments, the new size of the detail window and scale of the object of interest may persist for subsequent detail windows. For example, if the resized detail window with an object of interest at a particular scale is closed, but later a new detail window is opened, some embodiments may open the new detail window at the same size as the resized window, and with the object of interest displayed at the same scale. For other embodiments, the size of the resized window will only apply to the resized window itself, with new windows opening at a default or pre-configured size, and the object of interest also displayed at a default scale.

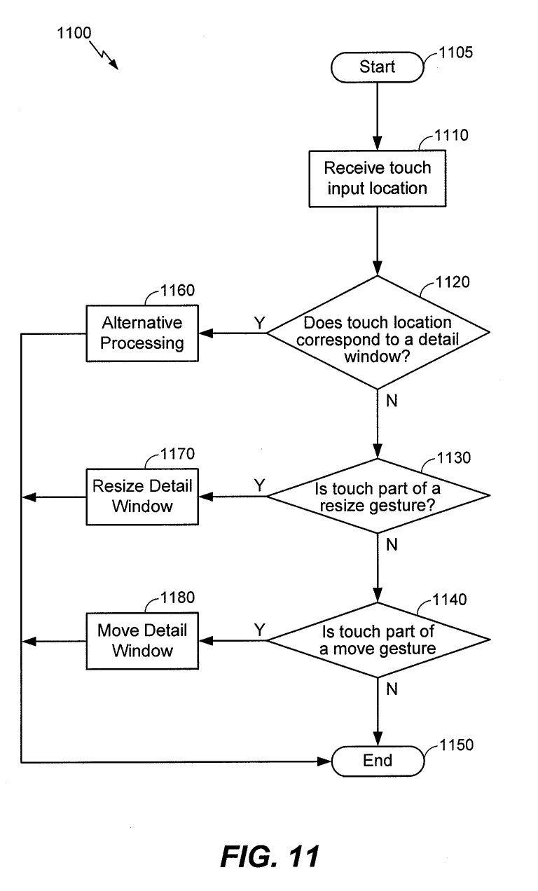

FIG. 11 is a flowchart illustrating one operative embodiment of a method implementing move and resize operations as illustrated in FIGS. 9-10. Process 1100 begins at start block 1105 and then moves to block 1110 where a touch input location is received. Process 1100 then moves to block 1120, and determines whether the touch input is within a detail window. If the touch input does not correspond to a detail window, no operations on detail windows are contemplated by process 1100 for this touch input, and process 1100 transfers control to alternate processing, for example, process 705 of FIG. 7. After this alternative processing is complete, process 1100 moves to end state 1150. If the touch input does correspond to a detail window location, process 1100 moves to decision block 1130, which determines whether the touch input indicates a resize gesture. If a resize operation is indicated, process 1100 moves to block 1170 where the detail window is resized according to the touch input. Process 1100 will then move to end state 1150. If the touch input does not indicate a resize gesture, process 1100 moves from block 1130 to block 1140, which determines whether the touch input is part of a move gesture. If a move gesture is indicated, process 1100 moves to block 1180, where the detail window is moved to a location indicated by the touch input. Process 1100 then moves to end state 1150.

Those having skill in the art will further appreciate that the various illustrative logical blocks, modules, circuits, and process steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. One skilled in the art will recognize that a portion, or a part, may comprise something less than, or equal to, a whole. For example, a portion of a collection of pixels may refer to a sub-collection of those pixels.

The various illustrative logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of non-transitory storage medium known in the art. An exemplary computer-readable storage medium is coupled to the processor such the processor can read information from, and write information to, the computer-readable storage medium. In the alternative, the storage medium may be integral to the processor. The processor and the storage medium may reside in an ASIC. The ASIC may reside in a user terminal, camera, or other device. In the alternative, the processor and the storage medium may reside as discrete components in a user terminal, camera, or other device.

Headings are included herein for reference and to aid in locating various sections. These headings are not intended to limit the scope of the concepts described with respect thereto. Such concepts may have applicability throughout the entire specification.

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. A method of providing a preview window in a digital imaging device, the method comprising:
capturing a digital image of a scene with an imaging sensor;
detecting a first object of interest in the digital image; and
displaying a combined image comprising at least a portion of the digital image at a first scale and at least a portion of the first object of interest at a second scale, wherein the second scale is larger than the first scale.

2. The method of claim 1, wherein the first object of interest is a face.

3. The method of claim 1, further comprising detecting a second object of interest in the digital image.

4. The method of claim 3, further comprising displaying at least a portion of the second object of interest at the second scale simultaneously with displaying the at least a portion of the first object of interest.

5. The method of claim 4, further comprising switching between the display of the at least a portion of the first object of interest and at least a portion of the second object of interest.

6. The method of claim 1, wherein the at least a portion of the first object of interest is displayed within a rectangle overlaid on a portion of the digital image.

7. The method of claim 1, further comprising changing the position of the at least a portion of the first object of interest on a electronic display.

8. The method of claim 7, wherein the changing of position is accomplished by a touch gesture, and wherein the electronic display is a touch screen display.

9. The method of claim 1, further comprising changing the scale of the at least a portion of the first object of interest on an electronic display.

10. The method of claim 9, wherein changing the scale of the at least a portion of the first object of interest is accomplished via a gesture on the electronic display, and wherein the electronic display is a touch screen display.

11. The method of claim 3, further comprising selecting the at least a portion of the first object of interest for display based on the relative distance of each object of interest from a center of the scene.

12. The method of claim 3, further comprising selecting the at least a portion of the first object of interest for display based on the relative size of the first object of interest compared to the second object of interest.

13. A digital imaging apparatus, comprising:
an imaging sensor;
an electronic display;
an imaging sensor control module, configured to capture a digital image of a scene with an imaging sensor;
an object of interest detection module configured to detect a first object of interest in the digital image; and
a window display module configured to display a combined image comprising at least a portion of the digital image at a first scale and at least a portion of the first object of interest at a second scale, wherein the second scale is larger than the first scale.

14. The apparatus of claim 13, wherein the first object of interest is a face, an insignia or text.

15. The apparatus of claim 13, wherein the object of interest detection module is further configured to detect a second object of interest in the digital image.

16. The apparatus of claim 15, wherein the window display module is configured to display at least a portion of the second object of interest at the second scale simultaneously with the display of the at least a portion of the first object of interest on the electronic display.

17. The apparatus of claim 14, wherein the at least a portion of the first object of interest is displayed within a rectangle overlaid on a portion of the digital image.

18. The apparatus of claim 17, further comprising a touch screen input module configured to detect a touch gesture on the display.

19. The apparatus of claim 13, wherein the apparatus is a wireless telephone.

20. A non-transitory computer readable medium, comprising instructions that when executed cause a processor to:
capture a digital image of a scene with an imaging sensor;
detect a first object of interest in the digital image; and
display a combined image comprising at least a portion of the digital image at a first scale and at least a portion of the first object of interest at a second scale on the electronic display, wherein the second scale is larger than the first scale.

21. The computer readable medium of claim 20, wherein the first object of interest is a face, an insignia or text.

22. The computer readable medium of claim 20, further comprising instructions that when executed cause a processor to detect a second object of interest in the digital image.

23. A digital imaging apparatus, comprising:
means for capturing a digital image of a scene with an imaging sensor;
means for detecting a first object of interest in the digital image; and
means for displaying a combined image comprising at least a portion of the digital image at a first scale and at least a portion of the object of interest at a second scale on an electronic display, wherein the second scale is larger than the first scale.

24. The digital imaging apparatus of claim 23, wherein the first object of interest is a face, an insignia, or text.

25. The apparatus of claim 23, further comprising means for detecting a second object of interest in the digital image.
